(19) United States
(12) Patent Application Publication
(10) Pub. No.: US 2025/0292069 A1
(43) Pub. Date: Sep. 18, 2025

(54) CONTEXT-BASED INITIATION OF GENERATIVE MACHINE LEARNING ACTIONS

(71) Applicant: Microsoft Technology Licensing, LLC, Redmond, WA (US)

(72) Inventor: Ryen William WHITE, Woodinville, WA (US)

(73) Assignee: Microsoft Technology Licensing, LLC, Redmond, WA (US)

(21) Appl. No.: 18/605,279

(22) Filed: Mar. 14, 2024

(51) Int. Cl. G06N 3/0475

(52) U.S. Cl. CPC G06N 3/0475

(57) ABSTRACT

This document relates to context-based initiation of generative machine learning actions. For instance, context information relating to user interface elements, constraints, tasks, and/or capabilities of available generative machine learning models can be employed to determine one or more candidate generative machine learning actions to offer to a user. When a user selects one of the candidate generative machine learning actions, the selected generative machine learning action can be triggered based on the context information.

### BACKGROUND

In recent years, generative machine learning models have demonstrated tremendous capability at generating content. For instance, generative language models can generate text to summarize existing documents, help users draft new documents, and conduct natural language conversations with users at a very high level. As another example, generative image models can generate realistic and/or aesthetically-pleasing images from language prompts, and can also modify existing images by restyling them and/or adding objects. However, generative machine learning models face certain obstacles to widespread adoption.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for initiating generative machine learning actions on a computing device. One example includes a computer-implemented method that can include detecting context information relating to one or more user interface elements displayed by an application executing on a computing device during a user interaction with the computing device. The computer-implemented method can also include identifying one or more candidate generative machine learning actions based at least on the context information relating to the one or more user interface elements displayed by the application. The computer-implemented method can also include outputting one or more identifiers of the one or more candidate generative machine learning actions. The computer-implemented method can also include receiving input identifying a selected identifier of a selected generative machine learning action. The computer-implemented method can also include triggering a generative machine learning model to perform the selected generative machine learning action based at least on the context information.

Another example entails a system that includes a processor and a storage medium storing instructions. When executed by the processor, the instructions can cause the system to detect context information relating to one or more user interface elements displayed by an application executing on the system during a user interaction with the system. The instructions can also cause the system to identify one or more candidate generative machine learning actions based at least on the context information relating to the one or more user interface elements displayed by the application. The instructions can also cause the system to output one or more identifiers of the one or more candidate generative machine learning actions. The instructions can also cause the system to receive input identifying a selected identifier of a selected generative machine learning action. The instructions can also cause the system to trigger a generative machine learning model to perform the selected generative machine learning action based at least on the context information.

Another example includes a computer-readable storage medium storing executable instructions which, when executed by a processor, cause the processor to perform acts. The acts can include detecting context information relating to one or more user interface elements displayed by an application executing on a computing device during a user interaction with the computing device. The acts can also include identifying one or more candidate generative machine learning actions based at least on the context information relating to the one or more user interface elements displayed by the application. The acts can also include outputting one or more identifiers of the one or more candidate generative machine learning actions on the computing device. The acts can also include receiving input identifying a selected identifier of a selected generative machine learning action. The acts can also include triggering a generative machine learning model to perform the selected generative machine learning action based at least on the context information.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of a generative language model, consistent with some implementations of the present concepts.

FIG. 2 illustrates an example generative image model, consistent with some implementations of the present concepts.

FIG. 3 illustrates a flowchart of a method or technique, consistent with some implementations of the disclosed techniques.

FIGS. 4A and 4B illustrate a first user experience, consistent with some implementations of the disclosed techniques.

FIGS. 5A and 5B illustrate a second user experience, consistent with some implementations of the disclosed techniques.

FIGS. 6A and 6B illustrate a third user experience, consistent with some implementations of the disclosed techniques.

FIG. 7 illustrates an example of a system in which the disclosed implementations can be performed, consistent with some implementations of the present concepts.

### DETAILED DESCRIPTION

### Overview

As noted above, generative machine learning models offer tremendous capabilities for generation of content, such as images and text. However, generally speaking, generative machine learning has not been widely integrated into everyday computing devices. While sophisticated users may be capable of efficiently utilizing generative machine learning to achieve computing tasks, most end users are not adept at employing generative machine learning models.

Furthermore, generative machine learning models tend to be general-purpose, as they are trained on a wide range of training data to perform tasks for a wide range of use cases. Often, generative machine learning models can be configured (e.g., via prompts or configuration options) to generate output that is appropriately tailored for specific use cases. However, automated approaches for configuring generative machine learning models for specific use cases have not been widely adopted.

The disclosed implementations offer techniques for selecting and initiating actions by generative machine learning models in a context-sensitive manner. By considering the context in which a user is engaged with a computing device, the disclosed implementations can offer the user context-appropriate options to initiate generative machine learning actions. For instance, context relating to user interface elements, constraints, task information, and/or capabilities of available generative machine learning models can be employed to determine one or more generative machine learning actions to offer to a user. The determination can be made by a generative machine learning model, using a hard-coded rules-based approach, etc.

### Machine Learning Overview

There are various types of machine learning frameworks that can be trained to perform a given task. Support vector machines, decision trees, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as ChatGPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video.

The term “prompt,” as used herein, refers to input provided to a generative model that the generative model uses to generate outputs. A prompt can include a query, e.g., a request for information from the generative language model. A prompt can also include context, or additional information that the generative language model uses to respond to the query. The term “in-context learning,” as used herein, refers to learning, by a generative model, from examples input to the model at inference time, where the examples enable the generative model to learn without performing explicit training, e.g., without updating model parameters using supervised, unsupervised, or semi-supervised learning.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Decoder-Based Generative Language Model

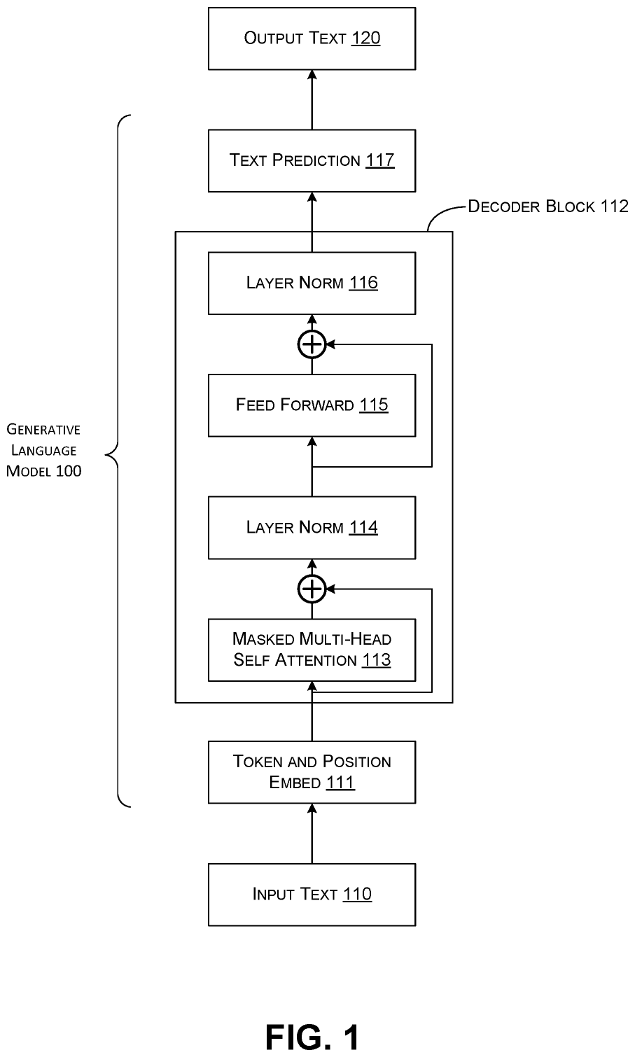

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user. For instance, the input text can include words, sentences, phrases, or other representations of language. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents (Radford, et al., “Improving language understanding by generative pre-training,” 2018). Then, a pretrained generative language model can be tuned using a reinforcement learning technique such as reinforcement learning from human feedback (“RLHF”).

### Example Generative Image Model

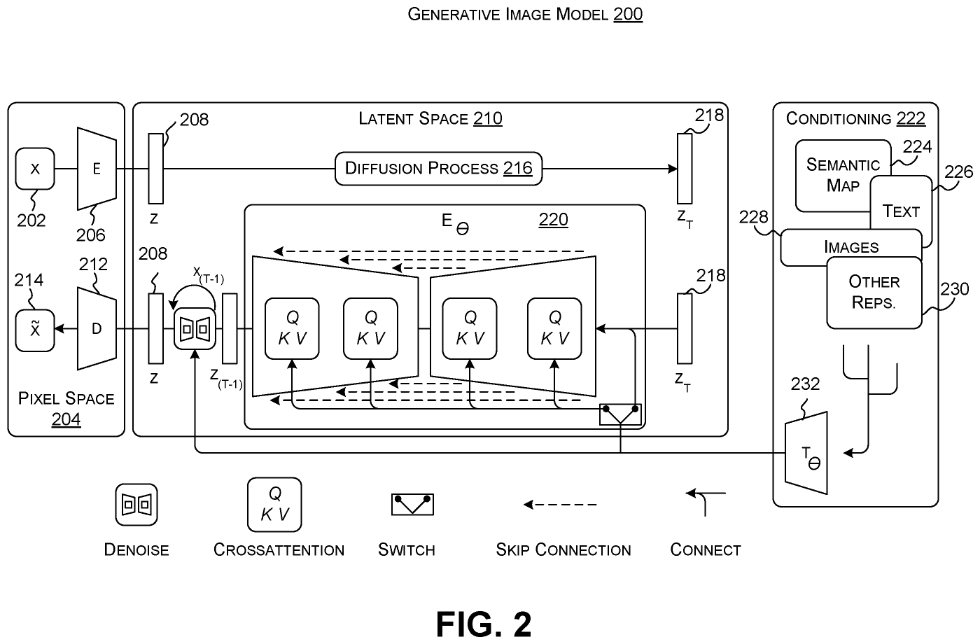

FIG. 2 illustrates an example generative image model 200. An image 202 (X) in pixel space 204 (e.g., red, green, blue) is encoded by an encoder 206 (E) into a representation 208 (Z) in a latent space 210. A decoder 212 (D) is trained to decode the latent representation Z to produce a reconstructed image 214 (X˜) in the pixel space. For instance, the encoder can be trained (with the decoder) as a variational autoencoder using a reconstruction loss term with a regularization term.

In the latent space 210, a diffusion process 216 adds noise to obtain a noisy representation 218 (Z_{T}). A denoising component 220 (E_{θ}) is trained to predict the noise in the compressed latent image Z_{T}. The denoising component can include a series of denoising autoencoders implemented using UNet 2D convolutional layers.

The denoising can involve conditioning 222 on other modalities, such as a semantic map 224, text 226, images 228, or other representations 230 which can be processed to obtain an encoded representation 232 (T_{θ}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 200 can be employed for text to image generation, where an image is generated from a text prompt. In other cases, generative image model 200 can be employed for image-to-image mode, where an image is generated using an input image as well as a text prompt. Generative image model 200 can also be employed for inpainting, where parts of an image are masked and remain fixed while the rest of the image is generated by the model, in some cases conditioned on a text prompt.

In some cases, generative image model 200 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 200, cloning the model into another copy. The copy is connected to the original model with one or more zero convolutional layers which are then optimized with the parameters of the copy. For instance, the ControlNet can be trained to preserve edges, lines, boundaries, human poses, from an image, semantic segmentations, object depth, etc. The outputs of a ControlNet can be added to connections within the denoising layer. Thus, the generative image model can produce images that are conditioned not only on text, but also aspects of another image.

### Generative Modes

Generative image model 200 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In an inpainting mode, the processing is similar to the image-to-image mode, but an image mask is used to determine which parts of the image are fixed to match the input image. The rest of the image is generated in a way that it is consistent with the fixed parts of the image. Note that the term “inpainting,” as used herein, includes filling in parts of a given image as well as extending an image outward.

### Example Method

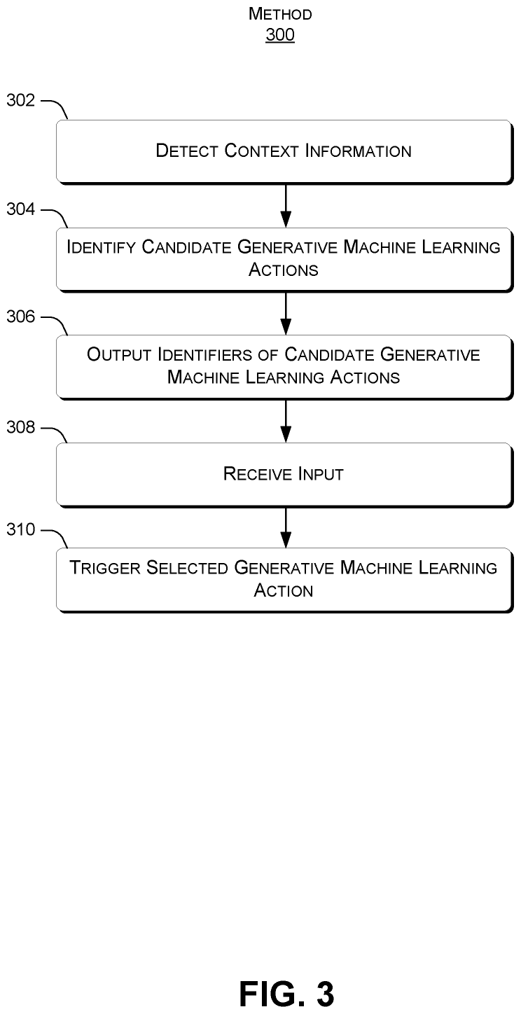

FIG. 3 illustrates an example computer-implemented method 300, consistent with some implementations of the present concepts. Method 300 can be implemented on many different types of devices, e.g., by one or more cloud servers, by a client device such as a laptop, tablet, or smartphone, or by combinations of one or more servers, client devices, etc.

Method 300 begins at block 302, where context information relating to user interaction with a computing device is detected. For instance, the context information can relate to user interface elements displayed on the computing device by an application, a task being performed on the computing device, constraints relating to the task, and/or capabilities of one or more generative machine learning models that are available to assist in performing the task.

Method 300 continues at block 304, where one or more candidate generative machine learning actions are identified based on the context information. For instance, the candidate generative machine learning actions can be identified using a generative machine learning model, a classifier, hard-coded rules, etc.

Method 300 continues at block 306, where identifiers of the one or more candidate generative machine learning actions are output. For instance, the one or more candidate generative machine learning actions can be offered to a user via a graphical user interface. In cases where multiple candidate generative machine learning actions are identified, they can also be ranked and output in ranked order.

Method 300 continues at block 308, where input identifying a selected generative machine learning action from the candidate generative machine learning actions is received. For instance, user input directed to the graphical user interface can choose one of the candidate generative machine learning actions, e.g., from a menu, button, or other user interface element.

Method 300 continues at block 310, where the selected generative machine learning action is triggered. For instance, some or all of the context information can be input to a generative machine learning model to perform the selected generative machine learning action. In some cases, block 310 can involve generating a prompt for the generative machine learning model that performs the selected generative machine learning action. Note that, in some cases, the generative machine learning model that is triggered to perform the selected generative machine learning action can be the same generative machine learning model that was employed at block 304 to identify the candidate generative machine actions.

### First Example User Experience

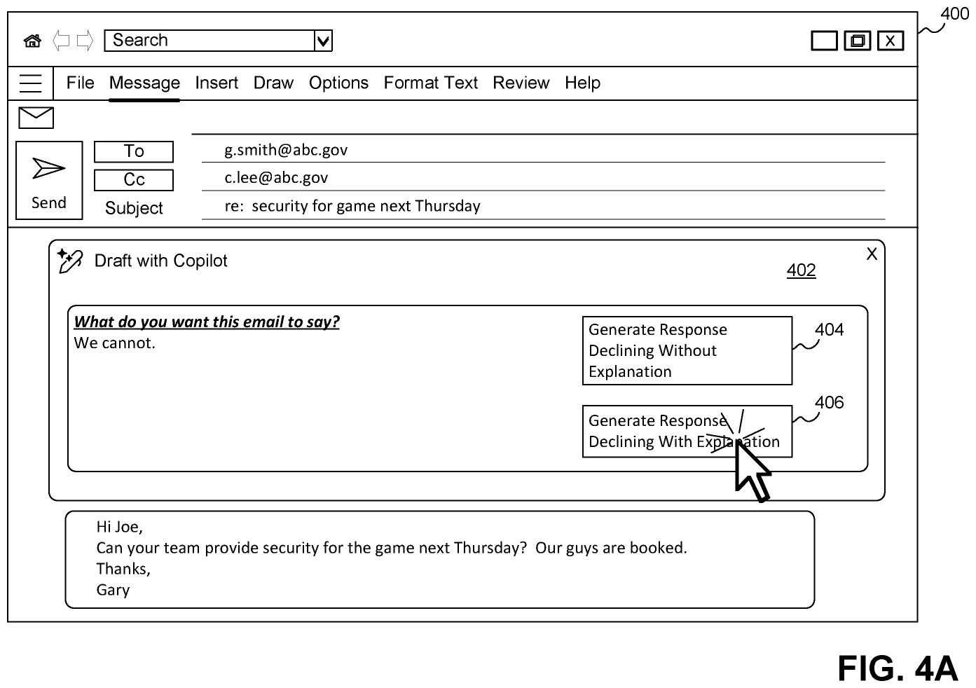

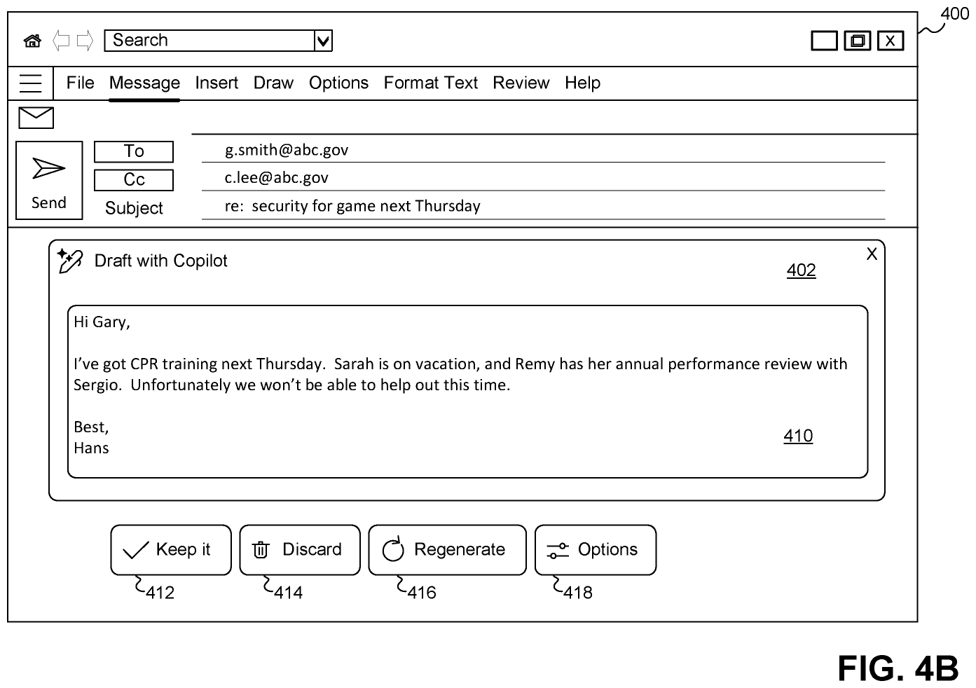

FIGS. 4A and 4B illustrate a first example user experience. An email interface 400 shows a user replying to an email. Here, the received email requests that the user's team provide security for a game next Thursday. For the purposes of the following example, assume that the recipient's team is unable to handle the request.

The email interface includes a copilot section 402, which enables the user to interact with a generative language model to generate the reply email. In this example, the user enters a brief message “we cannot” and then the user is offered two options for responding. A first graphical user interface element 404 allows the user to have the generative language model draft a response declining the request without an explanation, and a second graphical user interface element 406 allows the user to have the generate language model draft a response declining the request with an explanation.

Assuming the user accepts second graphical user interface element 406 to decline the request with explanation, the user experience may proceed as shown in FIG. 4B. Here, the generative language model generates a draft reply 410 explaining why each team member cannot be available. The user can select a “keep it” element 412 to keep the generated reply. Other elements include a discard element 414 to discard the generated reply and return to manually draft a response, a regenerate option 416 to regenerate a new draft reply, and an options element 418 which can allow the user to specify further options such as length and/or tone of the generated reply.

Referring back to FIG. 3, method 300 can be applied to result in the user experience shown in FIGS. 4A and 4B as follows. First, the context information detected at block 302 can reflect that the user is responding to an email, since the user is interacting with an email user interface element that accepts text. As a consequence, a textual response is likely appropriate, and generating a textual response is a capability of a generative language model. The context information can also include task information relating to the task that the user is attempting to accomplish, which involves drafting a reply declining the request. Additional task information can be obtained from other sources, e.g., the calendars of the recipient as well as their respective team members.

This context information can be provided to a generative language model with a request to generate one or more candidate generative machine learning actions. Here, the generative machine learning model can suggest one of two candidate generative machine learning actions-generating a response declining the request without explanation, and generating a response declining the request with explanation. For instance, a prompt could be input to the generative machine learning model, such as: “The user is replying to an email. Please output a ranked list of generative machine learning actions that could assist the user in replying to the email. You have access to the calendars of the user as well as their team members.” Given this prompt, the generative language model could generate a ranked list of two candidate generative machine learning actions-responding without explanation, and responding with explanation. Graphical user interface elements 404 and 406 can be dynamically generated for each candidate generative machine learning action.

When the user selects the graphical user interface element 406 to invoke the second candidate machine learning action, the generative language model (or another generative language model) can be prompted to generate a draft email reply. The prompt can include (1) a request that the generated reply decline the request, (2) the text of the email that the recipient is replying to, and (3) calendar information for members of the recipients' team. Given this information, the generative language model is able to generate a reply declining the request with an explanation why each team member is not available.

### Second Example User Experience

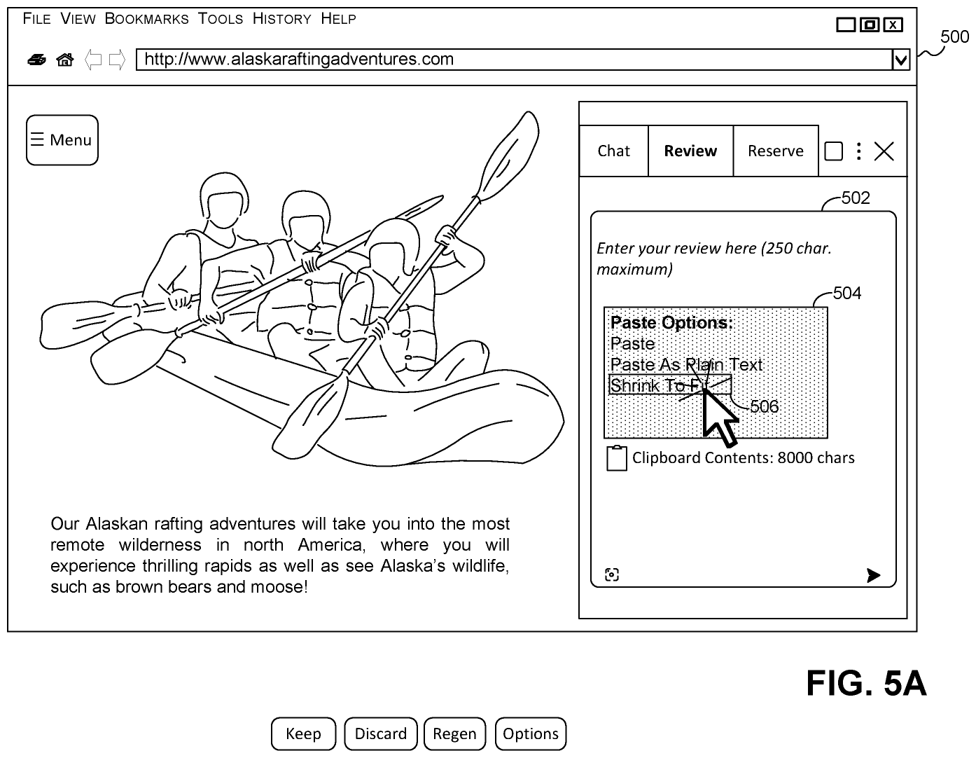

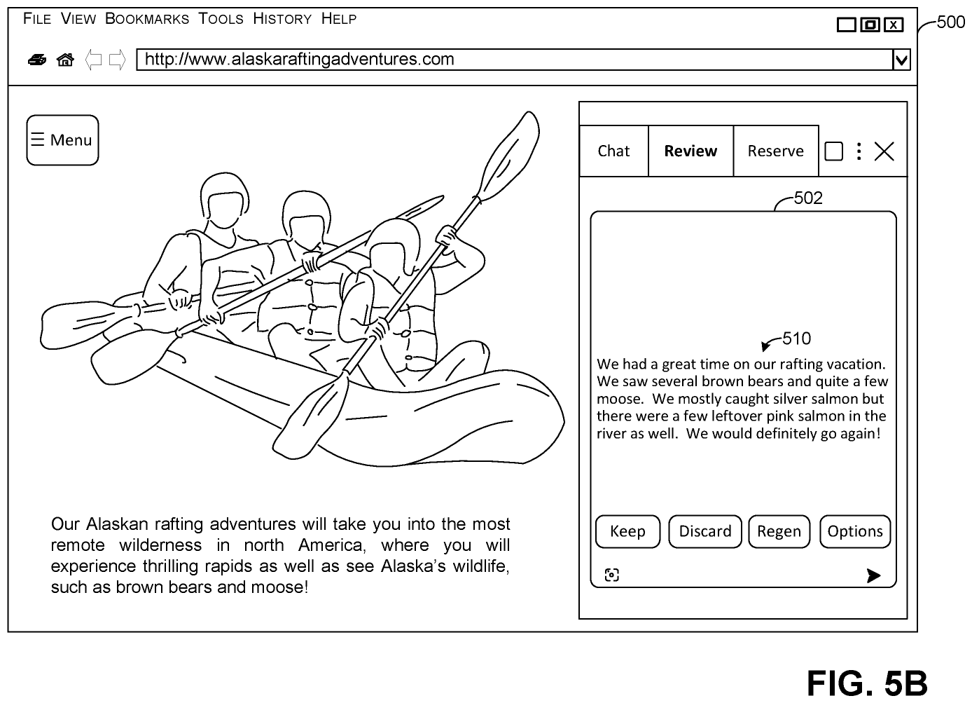

FIGS. 5A and 5B illustrate a second user experience. A web page 500 includes a text box 502 where a user wishes to enter a review for a rafting trip that they took in Alaska. Assume the user has previously written a very detailed description of their vacation, with 8000 characters, and copied it to the clipboard. However, as also shown in FIG. 5A, the text box has a limit of 250 characters.

When the user attempts to paste their lengthy review into the text box, paste menu 504 is shown to the user. Here, the paste menu includes user interface elements for paste actions such “paste” and “paste as plain text” that do not necessarily involve generative machine learning. However, the paste menu also includes a user interface element 506 for a shrink to fit action that can be implemented using a generative machine learning model.

Assume for the purposes of example that the user selects the user interface element 506 for the shrink to fit action. As shown in FIG. 5B, a generated summary 510 can be provided by a generative machine learning model. The generated summary describes the vacation based on the previous content of the clipboard but in far fewer characters. Again, the user can be provided with user interface elements that allow the user to keep the summary, discard the summary, regenerate the summary, or specify further options.

Referring back to FIG. 3, method 300 can be applied to result in the user experience shown in FIGS. 5A and 5B as follows. First, the context detected at block 302 can reflect that the user is interacting with a text box on a web page. As a consequence, a textual response is likely appropriate, and generating a textual response is a capability of a generative language model. The context can also include task information relating to the task that the user is attempting to accomplish, which involves submitting a review of a rafting vacation to a web site for a company that provides rafting vacations. In addition, here there is a constraint on the number of characters (250) that can be entered into the text box.

This context information can be provided to a generative language model with a prompt requesting that the generative machine learning model generate one or more candidate generative machine learning actions. Here, the generative machine learning model can suggest a single candidate generative machine learning action—shrinking the current contents of the clipboard to fit the text box. The user interface element 506 can be dynamically added to the paste menu 504 when the shrink to fit action is suggested as a candidate generative machine learning action.

When the user selects the user interface element 506 for the shrink to fit action, the generative language model (or another generative language model) can be prompted to generate a summary of the contents of the clipboard. The prompt can include (1) the current contents of the clipboard, (2) constraint information such as the maximum number of characters that can be entered into the text box, and (3) task information about the web page, such as the URL, alt text of images in the web page, other text on the web page, etc. Given this information, the generative language model is able to generate a summary of the current content of the clipboard that meets the size constraint of the text box and is appropriate given the task information.

### Third Example User Experience

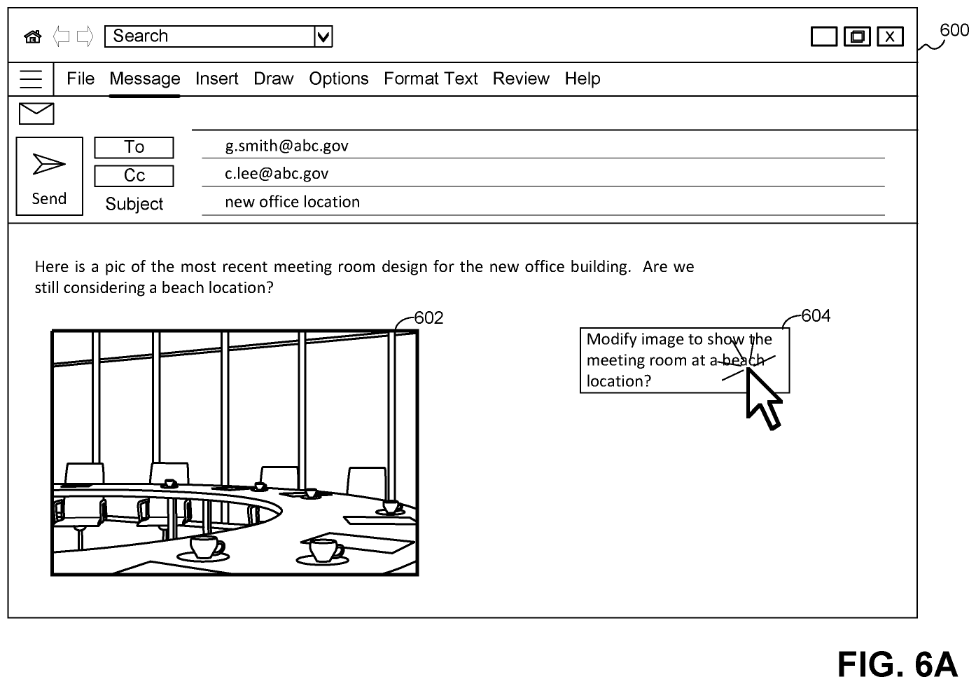

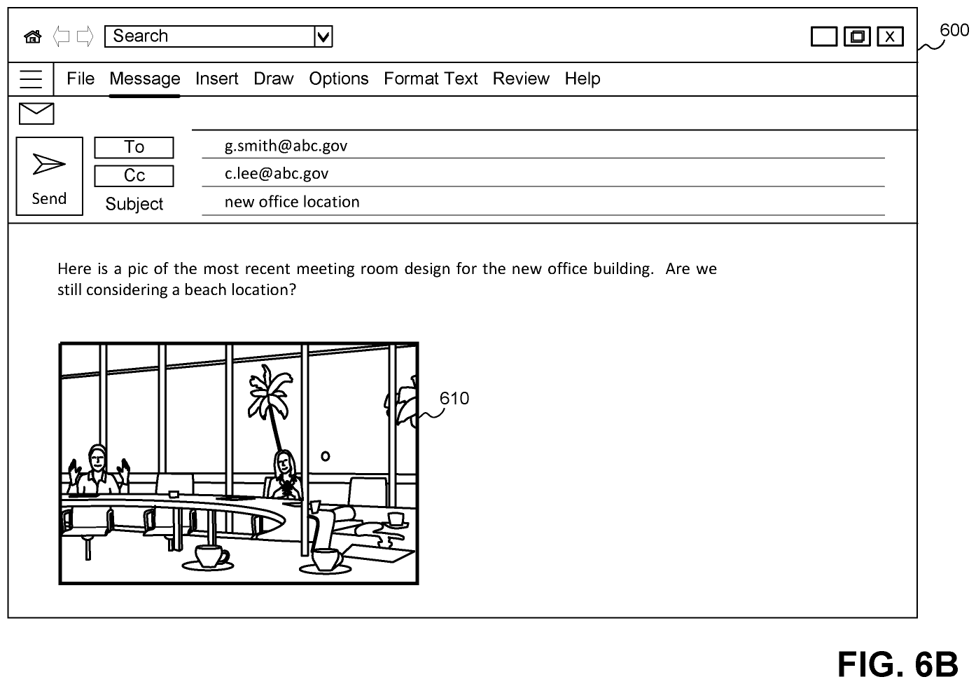

FIGS. 6A and 6B illustrate a third user experience. An email interface 600 shows a user sending an email with an inserted image 602. Here, the email asks the recipients whether the organization is still considering a beach location for the new office building. The email also states that the image is a picture of the most recent design for the meeting room of the new office building.

The email interface includes a user interface element 604 that allows the user the option to modify image 602 to show the meeting room at a beach location. When the user selects the suggested action, the email is modified as shown in FIG. 6B. Here, a generated image 610 has replaced image 602. The generated image shows the meeting room in a beach location, e.g., with palm trees and a sun setting over the beach in the background.

Referring back to FIG. 3, method 300 can be applied to result in the user experience shown in FIGS. 6A and 6B as follows. First, the context information detected at block 302 can reflect that the user is interacting with an email interface that has an inserted image. Thus, both text and image generation capabilities are plausible for generative machine learning actions relating to the email. The context information can also include task information relating to the task that the user is attempting to accomplish, which involves sending a picture of the most recent meeting room design to some colleagues. The task information also indicates that the user wants to know if the organization is still considering a beach location for the new office.

This context information can be provided to a generative language model with a request to generate one or more candidate generative machine learning actions. The context information can indicate that both generative language and generative image capabilities are available. Here, the generative machine learning model can suggest a single candidate generative machine learning action-modifying the image to show the proposed meeting room at a beach location. At this time, the user interface element 604 can be dynamically added to the email interface 600.

When the user selects the user interface element 604, a generative image model can be prompted to use image 602 as an image prior for restyling. The generative image model can be prompted with one or more words relating to a beach location. Given this information, the generative image model can generate the modified image 610, e.g., by adding users and beach scenery to the background of the image 602.

### Additional Implementations

The examples illustrated above are just a few plausible examples of how generative machine learning actions can be flexibly identified and integrated into computing experiences based on context. For instance, the description above employed examples of user interface elements relating to email supporting both text and image formats, and a web page element that only supported text format. However, there are many other types of user interface elements that can be found in other applications.

For instance, word processing documents can allow users to enter both text and images. Users can simply type to enter text when a cursor is present, or can use various menus to insert images. Thus, some implementations can consider whether the user is currently entering text or using a menu to insert an image to determine whether generative language actions or generative image actions are suggested.

As another example, consider a file explorer application. When a user hovers over a thumbnail of an image in a folder, the user could be offered an option to generate another image using the hovered-over image as an image prior. If the user hovers over a thumbnail of a text or word processing document, the user could be presented with an option to generate a summary of that document.

In addition, some implementations can identify both text and image generation options for a given scenario. Referring back to FIG. 6A, the user could also be given an additional option to modify the text of the email to indicate that the image has been modified to show a beach scene. As another example, the user could also be given the option to modify the image to add additional people (e.g., images of the recipients) seated in the chairs. Or consider an example where the text of the email says, “We'll need some blinds because of the bright sunlight coming from the west in the afternoon.” The user could be given an option to add blinds to the modified image. More generally, a sequence of candidate generative machine learning actions can be provided to a user, where the sequence includes various modalities of content generation.

In addition, various other use cases are contemplated. Consider a scenario where a user is watching a video and turns on closed captioning. At that time, the user could be provided with an option to translate the captions into another language. For instance, context describing the location of the user could be used to select a suggested language for the translation.

As another example use case, consider a long chain of emails between colleagues, some of whom are in favor of a particular restaurant for a meeting and some of whom are in favor of another restaurant. If a supervisor wishes to make a final decision, the supervisor can be provided with an option to summarize the arguments in the email thread for and against each option. The summary can also explain a rationale behind the decision.

As another example use case, consider a user that wishes to search for an answer to a complex question, such as “Who are the top 5 clutch hitters in baseball history?” A straightforward web search will likely yield a number of different articles with different theories. Some proponents will argue that statistics such as sacrifice fly balls or late-inning statistics are relatively more or less important than others. A user interacting with a search engine interface could be provided with an option to have a generative language model submit numerous generated queries to different search engines and retrieve documents from a diverse range of authors, e.g., sports writers, bloggers, statisticians, etc. Then, the generative language model could summarize the retrieved information with a single answer that identifies five baseball players along with reasoning for their selection as the top clutch hitters in history. In some cases, the answer could also provide some mentions of players that were not included, and why those players did not quite make the top five.

As another example use case, consider a user that is drafting an email and includes a 60 second video that shows a dog for about 10 consecutive seconds in the video. If the text of the email asks the recipients to direct their attention to the dog, then the user could be provided an option to have a generative machine learning model edit the video to remove the other 50 seconds of video that do not include the dog. This could be particularly useful if the video exceeds the attachment size limit before the editing.

As a further point, note that the character limit of text box 502 shown in FIG. 5A was provided as an example of a constraint. However, there are various other types of constraints that could influence which generative machine learning actions are appropriate in any given context. For instance, as noted above, some email applications have an attachment size limit. If a generative image model is instructed to generate images or video to attach to an email, the prompt to the model or a configuration parameter can be employed to ensure that the model output is within the size constraint for the attachment.

In addition, the character and attachment size limits mentioned above can be considered “hard” constraints—the text box and email applications simply will not function as intended if the constraints are not met. However, there can also be “soft” constraints that can be considered. Consider a user sending an email to a supervisor, where the user typically sends moderate-length emails to their supervisor (e.g., usually about three paragraphs). Some implementations can request that the generative language model generate a response that is within a normal range of length of the typical emails that the user sends to their supervisor, to avoid a response that is too short or too long.

There are also many different types of task information that can be pertinent when generating candidate generative machine learning actions. For instance, on a mobile phone, a user may generally have a preference for generating shorter text outputs than on a laptop or desktop, because the user is likely not in their office if they are using their mobile phone. Thus, some implementations may request shorter text outputs from a generative language model when a user is on their phone than on their laptop or desktop.

As another example, different models may have different capabilities. For instance, perhaps one model (e.g., GPT 3.5) is very capable at summarizing information but not at creative writing. Another model (e.g., GPT-4) may be far better at creative writing, but not much better than the first model at summarizing information. Further, assume the second model has many more parameters and uses far more computing resources, e.g., storage, memory, bandwidth, CPU cycles, etc. Some implementations can preferentially suggest the first model for summarization tasks and the second model for creative writing tasks. Thus, for instance, if a user starts writing a poem, the user can be prompted to employ the second model to assist, but if the user is summarizing an email chain, then the first model may be sufficient.

Additionally, note that some implementations may evaluate different types of context information together. For instance, user interface information can specify the type of actions that are appropriate in a given user interface context, e.g., text can be entered into text boxes, buttons can be clicked, images can be blurred, cropped, or sharpened, etc. On the other hand, capability information can convey the abilities of a given generative machine learning model to perform certain generative machine learning actions. Some implementations can prompt a generative machine learning model to identify candidate generative machine learning actions that are both appropriate given the user interface information but also capable of being performed by the generative machine learning models. Thus, the candidate generative machine learning actions can represent the intersection of the types of actions that are appropriate for the user interface elements while also capable of being performed by the available generative machine learning models.

In addition, some implementations may cache candidate generative machine learning actions for future use. Recall the scenario described above with respect to FIGS. 5A and 5B. Assume the user later accesses another web page with a text box having a character limit and attempts to paste from a clipboard with more characters than allowed by the text box. Instead of making another call to a generative language model to identify a “shrink to fit” action,' some implementations can cache the “shrink to fit” action along with the context information for later use. In the future, the current context information can be compared to cached context information. If there is a match between the current and cached context information, the previously-output candidate generative machine learning action can be output to the user.

In addition, some implementations can track user feedback relating to candidate generative machine learning actions. For instance, if users consistently tend to select certain generative machine learning actions and not other generative machine learning actions in certain contexts, then this information can be employed to adjust future rankings of candidate machine learning actions using a rules-based approach, reinforcement learning, etc.

### Example System

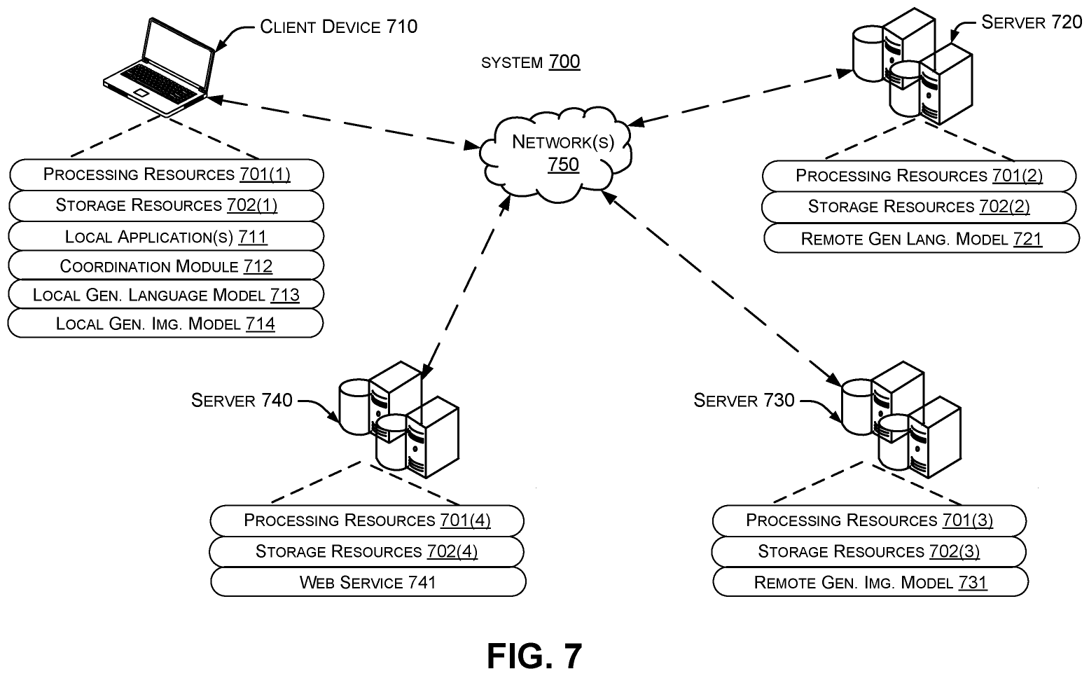

The present implementations can be performed in various scenarios on various devices. FIG. 7 shows an example system 700 in which the present implementations can be employed, as discussed more below.

As shown in FIG. 7, system 700 includes a client device 710, a server 720, a server 730, and a server 740, connected by one or more network(s) 750. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 7, but particularly the servers, can be implemented in data centers, server farms, etc.

Certain components of the devices shown in FIG. 7 may be referred to herein by parenthetical reference numbers. For the purposes of the following description, the parenthetical (1) indicates an occurrence of a given component on client device 710, (2) indicates an occurrence of a given component on server 720, (3) indicates an occurrence on server 730, and (4) indicates an occurrence on server 740. Unless identifying a specific instance of a given component, this document will refer generally to the components without the parenthetical.

Generally, the devices 710, 720, 730, and/or 740 may have respective processing resources 701 and storage resources 702, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include one or more local application(s) 711, such as an email client, web browser, word processing application, etc. The client device can also include a coordination module 712, which can coordinate generative machine learning actions as described more below. The client device can also include a local generative language model 713, e.g., a local instance of generative language model 100 as shown in FIG. 1. The client device can also include a local generative image model 714, e.g., a local instance of generative image model 200 as shown in FIG. 2.

Server 720 can host remote generative language model 721, e.g., a remote instance of generative language model 100 as shown in FIG. 1. Server 730 can host a remote generative language model 731, e.g., a remote instance of generative image model 200 as shown in FIG. 2. Server 740 can host web service 741, e.g., by serving one or more web pages accessible via client device 710.

The coordination module 712 on client device 710 can perform method 300. For instance, the coordination module can be part of an operating system of the client device, or provided as application software. The coordination module can gather context information relating to user interaction with the client device and/or another device, such as the web service 741 on server 740. The coordination module can then identify candidate machine learning actions suited for the context. In some cases, the coordination module can prompt the local generative language model 713 and/or the remote generative language model 721 to identify the candidate generative machine learning actions. In other cases, the coordination module can use a rules-based approach or another type of machine learning model (e.g., a classifier) to identify the candidate machine learning actions. The coordination module can also cause local application(s) 711 to dynamically generate user interface elements corresponding to the candidate generative machine learning actions, prompt any of the generative models to perform selected actions, and provide results of the selected actions to the local applications for output to the user.

### Technical Effect

As noted previously, generative machine learning has not been widely integrated into everyday computing devices. While sophisticated users can manually identify and prompt generative machine learning models to perform actions such as generating text or images, it is not straightforward to automate the initiation of generative machine learning actions on a computing device. For instance, depending on current user interaction with a computing device, different generative machine learning actions might be more or less appropriate.

For instance, consider a naïve implementation where users are offered the ability to generate a review using generative machine learning any time they interact with a user interface element on a web page for providing a review of a product or service. A generative machine learning model can generate a clearly understandable review with appropriate grammar, vocabulary, and tone for almost any scenario. However, different web pages may have different character limits for the review. By automating the prompting of a generative machine learning model to comply with the character limits, several technical benefits are obtained. First, the generated review will fit within the specified character limit. Second, computing resources dedicated to generating longer reviews and/or sending them over a network will not be wasted. Thus, constraint-based identification and triggering of generative language models can conserve computing resources and prevent errors on web pages.

The email attachment size limitation described above is another example of how the disclosed techniques can preserve computing resources. Consider a naïve alternative where generative image models are employed to modify user images any time they are attached to an email, without consideration of attachment size limits. Not only will the email application not function as intended, but computing resources dedicated to generating the images would be wasted. This is an example of how constraint-based identification and triggering of a generative image model can conserve computing resources and prevent errors involving an email application.

Similarly, the use of context information relating to user interface elements can also avoid wasting of computing resources. Offering users the ability to generate an image for a text-only user interface element is wasteful. Likewise, offering users the ability to generate text for a user interface element expecting an image (e.g., an element for uploading an image to an image repository) is also wasteful. By automating the usage of generative machine learning models in context-sensitive manner that considers the type of data formats accepted by given user interface element, it is possible to avoid unnecessary errors and also conserve computing resources involved in generating content that is not suited for the current user interaction.

Likewise, the use of task information relating to user interface elements can also avoid wasting of computing resources. For instance, consider the example above of a user responding to a long email chain. By considering context such as the recipients of the email and the previous emails in the chain, a generative machine learning action such as summarizing arguments in the email chain can be done in an appropriate manner. By using an appropriate tone (e.g., professional) and an appropriate length (e.g., based on previous emails to other users in the thread), the likelihood of generating a suitable response is high. As a consequence, the user is less likely to request regeneration of a new response and/or decide to discard the response and manually generate their own response. Once again, this prevents wasting of computing resources.

As a related point, consideration of model capabilities can also mitigate the wasting of computing resources. For instance, as noted previously, a more computationally-expensive model (e.g., GPT-4) can be employed for limited scenarios where creative writing is involved, whereas a less computationally-expensive model (e.g., GPT-3.5) can be employed for summarization. This resource-sensitive selection of generative machine learning actions can further reduce wasting of computing resources.

### Device Implementations

As noted above with respect to FIG. 7, system 700 includes several devices, including a client device 710, a server 720, a server 730, and a server 740. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### Additional Examples

Various examples are described above. Additional examples are described below. One example includes a computer-implemented method comprising detecting context information relating to one or more user interface elements displayed by an application executing on a computing device during a user interaction with the computing device, identifying one or more candidate generative machine learning actions based at least on the context information relating to the one or more user interface elements displayed by the application, outputting one or more identifiers of the one or more candidate generative machine learning actions, receiving input identifying a selected identifier of a selected generative machine learning action, and triggering a generative machine learning model to perform the selected generative machine learning action based at least on the context information.

Another example can include any of the above and/or below examples where the computer-implemented method further comprises identifying the one or more candidate generative machine learning actions by inputting the context information to a particular generative machine learning model.

Another example can include any of the above and/or below examples where the particular generative machine learning model is a decoder-based generative language model.

Another example can include any of the above and/or below examples where the context information includes constraint information describes one or more constraints associated with the one or more user interface elements, the particular generative machine learning model identifying the one or more candidate generative machine learning actions based at least on the constraint information.

Another example can include any of the above and/or below examples where the constraint information conveys a character limit of a text box.

Another example can include any of the above and/or below examples where the constraint information conveys an attachment size limit for an email attachment.

Another example can include any of the above and/or below examples where the context information includes capability information describes capabilities of one or more available generative machine learning models.

Another example can include any of the above and/or below examples where the computer-implemented method further comprises prompting the particular generative machine learning model to identify the one or more candidate generative machine learning actions based at least on the capability information describing the capabilities of one or more available generative machine learning models and the constraint information describing the one or more constraints associated with the one or more user interface elements.

Another example can include any of the above and/or below examples where the context information includes task information describes a task associated with the user interaction, the particular generative machine learning model identifying the one or more candidate generative machine learning actions based at least on the task information.

Another example can include any of the above and/or below examples where the task information relates to text or images displayed on the computing device that are associated with the task.

Another example can include any of the above and/or below examples where the computer-implemented method further comprises caching the one or more candidate generative machine learning actions in a cache, detecting other context information relating to another user interaction with the computing device, and based at least on similarity of the other context information to the context information, retrieving the one or more candidate generative machine learning actions from the cache without invoking the particular generative machine learning model.

Another example can include any of the above and/or below examples where the computer-implemented method further comprises identifying the one or more candidate generative machine learning actions by applying one or more rules to the context information.

Another example can include any of the above and/or below examples where the computer-implemented method further comprises tracking user feedback relating to individual candidate generative machine learning actions and identifying subsequent candidate generative machine learning actions based at least on the user feedback.

Another example includes a system comprising a processor and a storage medium storing instructions which, when executed by the processor, cause the system to detect context information relating to one or more user interface elements displayed by an application executing on the system during a user interaction with the system, identify one or more candidate generative machine learning actions based at least on the context information relating to the one or more user interface elements displayed by the application, output one or more identifiers of the one or more candidate generative machine learning actions, receive input identifying a selected identifier of a selected generative machine learning action, and trigger a generative machine learning model to perform the selected generative machine learning action based at least on the context information.

Another example can include any of the above and/or below examples where the instructions, when executed by the processor, cause the system to identify the one or more candidate generative machine learning actions by prompting a particular generative machine learning model with the context information, the particular generative machine learning model outputting the one or more candidate generative machine learning actions in response to the prompting.

Another example can include any of the above and/or below examples where the one or more candidate generative machine learning actions include generating text by a generative language model based on the context information.

Another example can include any of the above and/or below examples where the one or more candidate generative machine learning actions include generating an image or video by a generative image model based on the context information.

Another example can include any of the above and/or below examples where the instructions, when executed by the processor, cause the system to rank individual candidate machine learning actions relative to one another based at least on the context information and output the individual candidate machine learning actions in ranked order.

Another example can include any of the above and/or below examples where the instructions, when executed by the processor, cause the system to trigger a particular generative machine learning model to perform a particular candidate generative machine learning action prior to receiving the input and output content generated via the particular candidate generative machine learning action for selection by a user.

Another example includes a computer-readable storage medium storing instructions which, when executed by a processing device, cause the processing device to perform acts comprising detecting context information relating to one or more user interface elements displayed by an application executing on a computing device during a user interaction with the computing device, identifying one or more candidate generative machine learning actions based at least on the context information relating to the one or more user interface elements displayed by the application, outputting one or more identifiers of the one or more candidate generative machine learning actions on the computing device, receiving input identifying a selected identifier of a selected generative machine learning action, and triggering a generative machine learning model to perform the selected generative machine learning action based at least on the context information.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
detecting context information relating to one or more user interface elements displayed by an application executing on a computing device during a user interaction with the computing device;
identifying one or more candidate generative machine learning actions based at least on the context information relating to the one or more user interface elements displayed by the application;
outputting one or more identifiers of the one or more candidate generative machine learning actions;
receiving input identifying a selected identifier of a selected generative machine learning action; and
triggering a generative machine learning model to perform the selected generative machine learning action based at least on the context information.

2. The computer-implemented method of claim 1, further comprising identifying the one or more candidate generative machine learning actions by inputting the context information to a particular generative machine learning model.

3. The computer-implemented method of claim 2, the particular generative machine learning model being a decoder-based generative language model.

4. The computer-implemented method of claim 2, the context information including constraint information describing one or more constraints associated with the one or more user interface elements, the particular generative machine learning model identifying the one or more candidate generative machine learning actions based at least on the constraint information.

5. The computer-implemented method of claim 4, the constraint information conveying a character limit of a text box.

6. The computer-implemented method of claim 4, the constraint information conveying an attachment size limit for an email attachment.

7. The computer-implemented method of claim 4, the context information including capability information describing capabilities of one or more available generative machine learning models.

8. The computer-implemented method of claim 7, further comprising:
prompting the particular generative machine learning model to identify the one or more candidate generative machine learning actions based at least on the capability information describing the capabilities of one or more available generative machine learning models and the constraint information describing the one or more constraints associated with the one or more user interface elements.

9. The computer-implemented method of claim 2, the context information including task information describing a task associated with the user interaction, the particular generative machine learning model identifying the one or more candidate generative machine learning actions based at least on the task information.

10. The computer-implemented method of claim 9, the task information relating to text or images displayed on the computing device that are associated with the task.

11. The computer-implemented method of claim 2, further comprising:
caching the one or more candidate generative machine learning actions in a cache;
detecting other context information relating to another user interaction with the computing device; and
based at least on similarity of the other context information to the context information, retrieving the one or more candidate generative machine learning actions from the cache without invoking the particular generative machine learning model.

12. The computer-implemented method of claim 1, further comprising identifying the one or more candidate generative machine learning actions by applying one or more rules to the context information.

13. The computer-implemented method of claim 1, further comprising:
tracking user feedback relating to individual candidate generative machine learning actions; and
identifying subsequent candidate generative machine learning actions based at least on the user feedback.

14. A system comprising:
a processor; and
a storage medium storing instructions which, when executed by the processor, cause the system to:
detect context information relating to one or more user interface elements displayed by an application executing on the system during a user interaction with the system;
identify one or more candidate generative machine learning actions based at least on the context information relating to the one or more user interface elements displayed by the application;
output one or more identifiers of the one or more candidate generative machine learning actions;
receive input identifying a selected identifier of a selected generative machine learning action; and
trigger a generative machine learning model to perform the selected generative machine learning action based at least on the context information.

15. The system of claim 14, wherein the instructions, when executed by the processor, cause the system to:
identify the one or more candidate generative machine learning actions by prompting a particular generative machine learning model with the context information,
the particular generative machine learning model outputting the one or more candidate generative machine learning actions in response to the prompting.

16. The system of claim 14, the one or more candidate generative machine learning actions including generating text by a generative language model based on the context information.

17. The system of claim 14, the one or more candidate generative machine learning actions including generating an image or video by a generative image model based on the context information.

18. The system of claim 14, wherein the instructions, when executed by the processor, cause the system to:
rank individual candidate machine learning actions relative to one another based at least on the context information; and
output the individual candidate machine learning actions in ranked order.

19. The system of claim 14, wherein the instructions, when executed by the processor, cause the system to:
trigger a particular generative machine learning model to perform a particular candidate generative machine learning action prior to receiving the input; and
output content generated via the particular candidate generative machine learning action for selection by a user.

20. A computer-readable storage medium storing instructions which, when executed by a processing device, cause the processing device to perform acts comprising:
detecting context information relating to one or more user interface elements displayed by an application executing on a computing device during a user interaction with the computing device;
identifying one or more candidate generative machine learning actions based at least on the context information relating to the one or more user interface elements displayed by the application;
outputting one or more identifiers of the one or more candidate generative machine learning actions on the computing device;
receiving input identifying a selected identifier of a selected generative machine learning action; and
triggering a generative machine learning model to perform the selected generative machine learning action based at least on the context information.
